(19) United States
(12) Patent Application Publication
(10) Pub. No.: US 2012/0037677 A1
(43) Pub. Date: Feb. 16, 2012

(54) CONTAINER HOLDER FOR A BICYCLE

(76) Inventor: Keith Edward Valiquette, Waynesville, OH (US)

(21) Appl. No.: 13/190,008

(22) Filed: Jul. 25, 2011

Related U.S. Application Data
(60) Provisional application No. 61/373,313, filed on Aug. 13, 2010.

(51) Int. Cl. B62J 11/00

(52) U.S. Cl. 224/414

(57) ABSTRACT

A container holder for mounting onto a bicycle and for holding a container. The container holder having a receptacle for holding the container and attachment devices for mounting onto a frame or handle bars of a bicycle, particularly without tools. The holder is adapted to hold various bottles of liquid and containers.

### CROSS-REFERENCE TO RELATED APPLICATIONS

This application claims benefit to the Provisional Application Ser. No. 61/373,313 filed Aug. 13, 2010, which is incorporated by reference herein in its entirety.

### FIELD OF TECHNOLOGY

The present disclosure relates to specialized container holders adapted to mount onto a bicycle frame. More particularly, a container holder adapted to mount onto aerobars of a bicycle.

### BACKGROUND

Recreational and competitive cycling continues to grow as communities make their cities more bicycle friendly and increase bike to work initiatives. As a result, cyclists carry a variety of accessories. Long rides require cyclists to carry cooling liquids to replenish fluids lost during long rides.

A common holder is typically mounted to the bicycle frame. For example, the container holder commonly consists of a metal cage mounted directly to mounting holes brazed to the tubular frame using screws to connect into the mounting holes in order to connect the cage to the frame. A typical wire cage is designed to accept and hold a cylindrical shaped container of a standard size with a friction fit.

### SUMMARY

The present disclosure shows and describes a container holder adapted to be attached to a bicycle. More particularly, a container holder for mounting on a bicycle that includes a base member, two flexible attachments integral to the base member adapted to connect to handle bars of a bicycle, two flexible, U-shaped straps integral to the base member and at least partially forming a cylindrical space for holding the container therein, and an end stop connected to the base member.

### DESCRIPTION OF DRAWINGS

While the specification concludes with claims which particularly point out and distinctly claim the invention, it is believed the present disclosure will be better understood from the following description of certain examples taken in conjunction with the accompanying drawings. In the drawings, like numerals represent like elements throughout the several views.

FIG. 1 is a top view of an embodiment of a container holder;

FIG. 2 is a rear view of the container holder of FIG. 1;

FIG. 3 is a front view of the container holder of FIG. 1;

FIG. 4 is a left side elevational view of the container holder of FIG. 1;

FIG. 5 is a bottom view of the container holder of FIG. 1;

FIG. 6 is a left side perspective view of a container holder mounted to aerobars of a bicycle; and

FIG. 7 is a right side perspective view of an embodiment of a container holder connected to an aerobar and holding a water bottle within the holder.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION OF THE PREFERRED EMBODIMENTS

The following text sets forth a broad description of numerous different embodiments of the present disclosure. The description is to be construed as exemplary only and does not describe every possible embodiment since describing every possible embodiment would be impractical, if not impossible, and it will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

It should also be understood that, unless a term is expressly defined in this patent using the sentence “As used herein, the term ‘_’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). No term is intended to be essential to the present invention unless so stated. To the extent that any term recited in the claims at the end of this patent is referred to in this patent in a manner consistent with a single meaning, that is done for sake of clarity only so as to not confuse the reader, and it is not intended that such a claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

Specifically, the present invention includes an improvement over frame-mounted holders to securely hold a container in place on a bicycle. In one embodiment, a container holder is adapted to be mounted to bicycle aerobars for easy access to the container being held within the holder.

Not to be limited by theory, it has been discovered that many cyclists are carrying larger containers that do not properly fit into the convention container cages (i.e., holders). It has also been discovered that a container holder must be able to withstand vibration over a variety of terrain and larger containers in conventional holders have a tendency to fall out if the holder is not properly sized.

Moreover, not to be limited by theory, it has also been discovered that due to the design of convention container holders requiring a cyclist to insert and/or remove a container from them in a path parallel to the bicycle frame, a cyclist's attention can be distracted by such insertion or removal of the container rather than focusing on the terrain and/or traffic being encountered.

Additionally, more cyclists are using aerobars to reduce drag and improve aerodynamics. As a result, it has been discovered that there is a need for a container holder that is simple in design, lightweight, aerodynamic, capable of holding multiple size containers, easy to connect and disconnect from the bicycle, capable of being mounted easily to multiple style bicycle handle bars (including aerobars), low cost, convenient to access a container, and/or easy to insert and/or remove a container therefrom. In one or more embodiment herein, the container holder may also be used to secure other accessories that are in a form similar to a bottle.

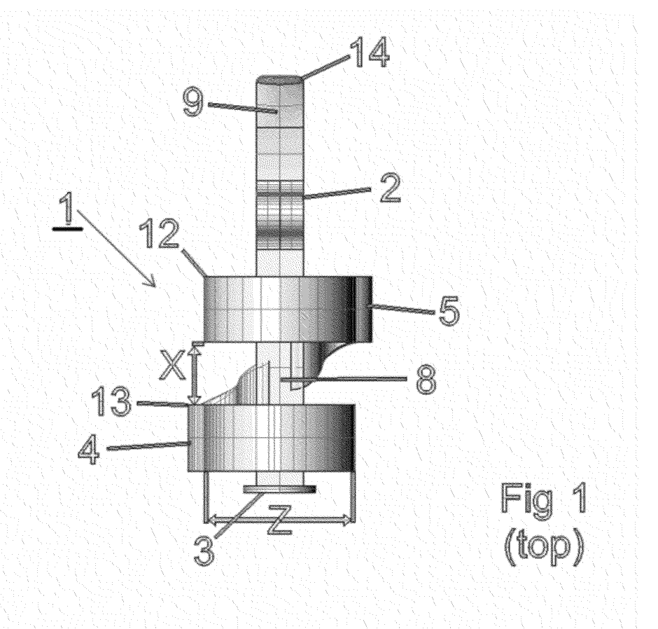

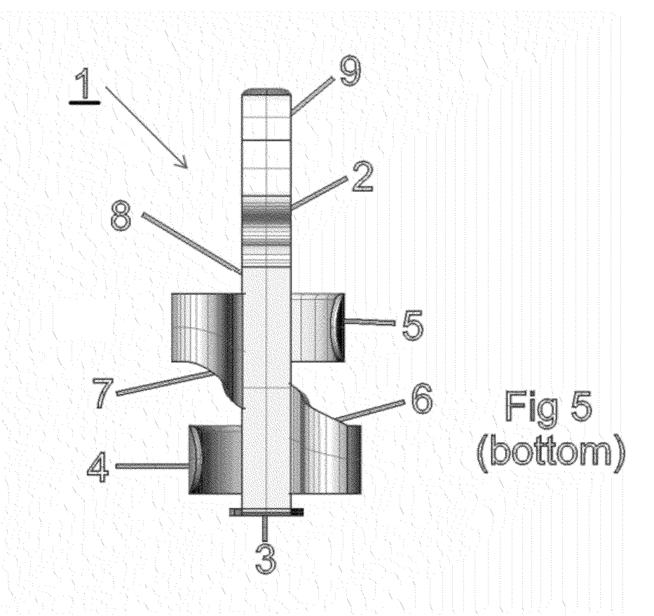

Referring to FIGS. 1-7, an embodiment of a container holder (1) is shown which adapted to hold a container such as, for example, a water bottle 30. In this non-limiting embodiment, the container holder (1) is fabricated from ABS plastic. In other non-limiting embodiments, the container holder (1) may be fabricated from nylon, carbon fiber, polymers, or other conventional materials capable of providing a combination of strength, flexibility, and weight reduction. In one embodiment, the container holder (1) is ideal for containers from about 3 inches in diameter to about 4 inches in diameter. However, it is understood that the container holder may be designed to fit other container sizes and/or diameters as well.

In the embodiment shown, the container holder (1) may comprise a base (8), a first strap (5), a second strap (4), a front rest (9), a articulating lip (2), an end stop (3), a first attachment (7), and a second attachment (6).

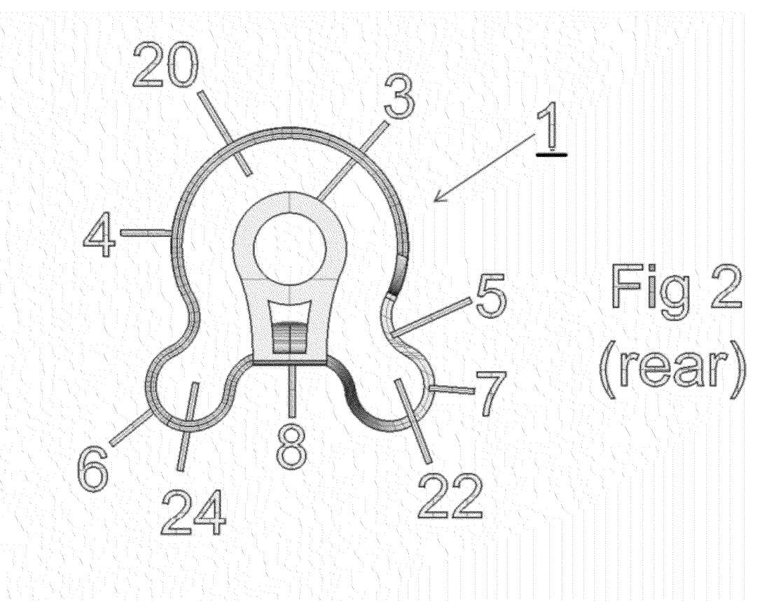

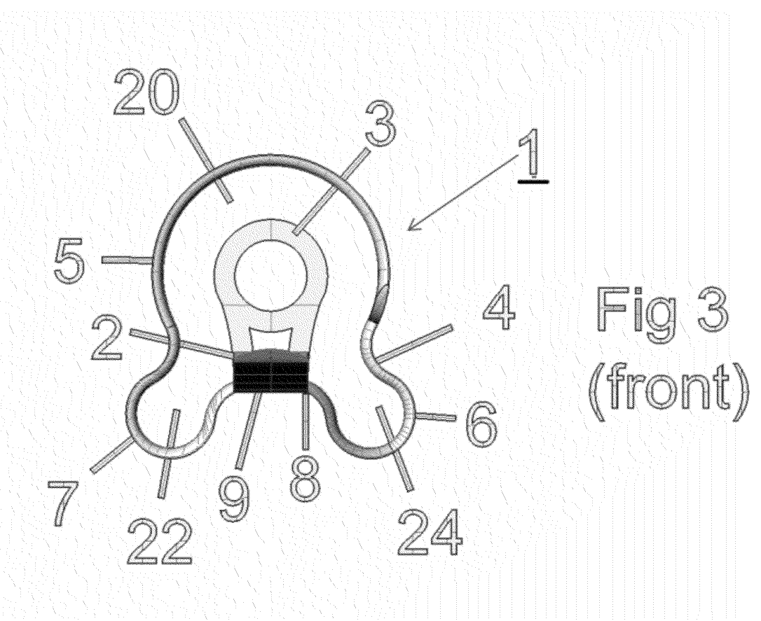

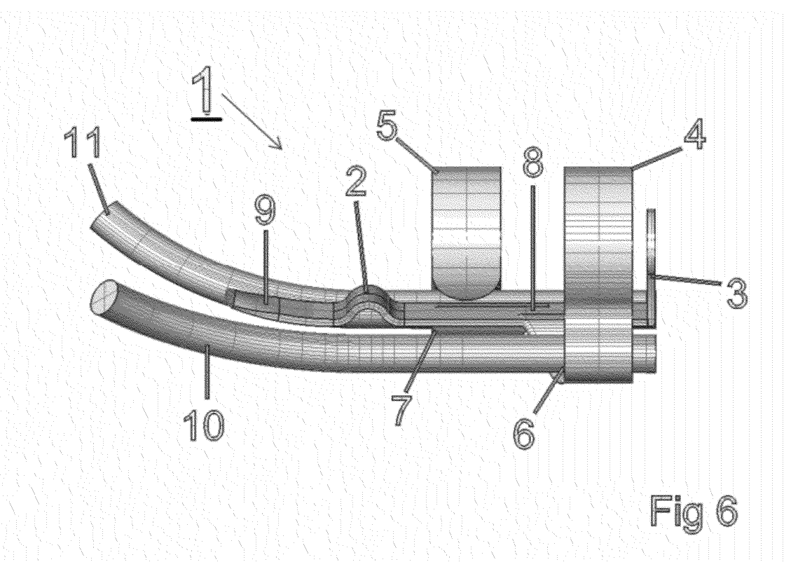

Specifically, the first attachment (7) extends from the base (8) and may comprise an arc having an angle of at least about 180 degrees, in another embodiment at least about 200 degrees, in another embodiment at least about 225 degrees, in yet another embodiment at least about 250 degrees, in still yet another embodiment at least about 300 degrees, and/or in still yet another embodiment at least about 335 degrees. The arc of the first attachment (7) may form a partial and/or substantially cylindrical shape that defines a first attachment space (22) as shown in FIGS. 2 and 3. The first attachment is adapted to partially encircle and/or grip a first bar (11) of an aerobar (50) such that this bar (11) is disposed within the first attachment space (22) (see, e.g., FIGS. 6, 7, and 8). As such, the first attachment (7) with its arc may have an inwardly biasing spring force due to its curvature and/or material properties to grip the bar (11) through a friction fit. As understood by one of ordinary skill in the art, the aerobar (50) is a type of handle bar mountable to a bicycle.

The second attachment (6) extends from the base (8) on a side opposite the first attachment (7). Additionally, the second attachment (6) is spaced a distance Y along the base (8) (i.e., along a longitudinal axis L-L′) from the first attachment (7). The distance Y may comprise from about 0 mm to about 150 mm, in another embodiment from about 15 mm to about 85 mm, in yet another embodiment from about 20 mm to about 70 mm, and in still yet another embodiment from about 27 mm to about 67 mm. In one embodiment the distance Y is about 37 mm. The container holder may comprise a width (z) from about 0 mm to about 200 mm, in one embodiment from about 25 mm to about 150 mm, in another embodiment from about 50 mm to about 125 mm, in yet another embodiment from about 75 mm to about 100 mm, and still yet another embodiment from about 90 mm to about 100 mm. The width (z) in one embodiment is about 96 mm.

Also, the second attachment may comprise an arc having an angle of at least about 180 degrees, in another embodiment at least about 200 degrees, in another embodiment at least about 225 degrees, in yet another embodiment at least about 250 degrees, in still yet another embodiment at least about 300 degrees, and/or in still yet another embodiment at least about 335 degrees. The arc of the second attachment (6) may form a partial and/or substantially cylindrical shape that defines a second attachment space (24) as shown in FIGS. 2 and 3. The second attachment is adapted to partially encircle a second bar (10) of the aerobar (50) such that this bar (10) is disposed within the second attachment space (24) as shown in FIGS. 6 and 8. As such, the second attachment (6) with its arc may have an inwardly biasing spring force due to its curvature and/or material properties to grip the bar (10) of the aerobar (50) through a friction fit in combination with the oppositely opposing first attachment (7) (see, e.g., FIGS. 6, 7, and 8).

In the embodiment shown, the first and second attachments (7) and (6), respectively, are integral with the base (8) and also made of the same material as the base, including but not limited to the materials set forth above herein. The material used to fabricate the first and second attachments may comprise a material that is resilient and/or has a memory sufficient to cause the first and second attachments to return to their original shape and/or resting position after being bent, deformed, and/or manipulated such as during the installation and/or removal of the holder 1 from the aerobar 50 of a bicycle. It is understood that in other embodiments, the first and second attachments may not be integral with the base and/or may not be made of the same material as the base.

In the embodiment shown, since the first attachment (7) and second attachment (6) are integral with the base (1), the container holder (1) does not require mechanical fasteners such as mechanical clamps, ratcheted ties, screws, bolts, or other commonly available hardware. Thus, in one embodiment, the container holder (1) does not include separate mechanical fasteners, only first and second attachments that are integral to the base (8).

Although shown as adapted for connection and/or mounting to an aerobar, it is understood that the holder (1) and its first and second attachments (7) and (6) may be adapted and/or designed to fit other handle bar, aerobar, and/or bicycle frame designs, configurations, and/or dimensions such as for example, wherein the container holder includes only a single attachment having a single attachment space for connecting to a bar of a bicycle frame. The single attachment may be fabricated and curved with an arc similar to or the same as the first attachment (7) shown and described herein. Such a design enables the easy connecting and disconnecting of the container holder from the frame rather than using screws or other separate mechanical connection devices such as clamps or fasteners.

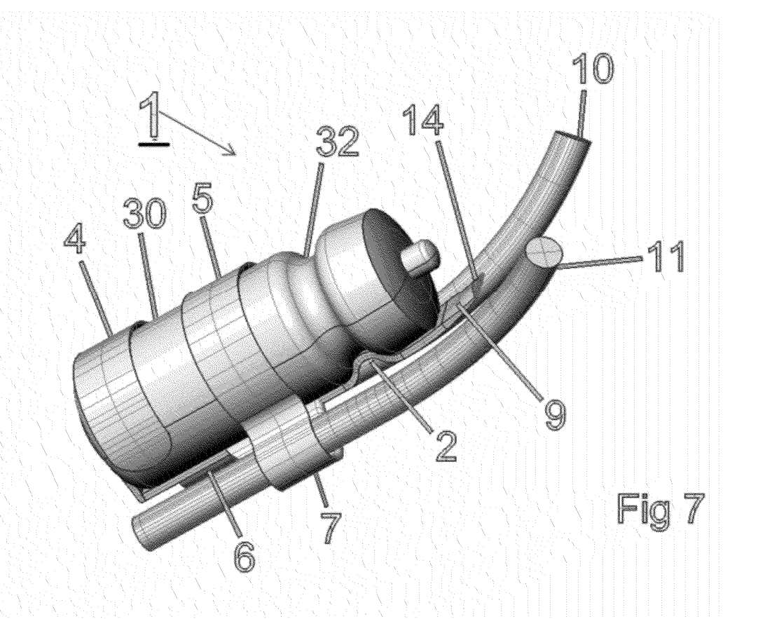

As set forth above, the container holder (1) may comprise the first strap (5) and second strap (4) connected to the base (8). In the embodiment shown in FIGS. 1-5, the first strap (5) extends from the first attachment (7) (which extends from the base (8)) and may comprise an arc having an angle of at least about 180 degrees, in another embodiment at least about 200 degrees, in another embodiment at least about 225 degrees, in yet another embodiment at least about 250 degrees, in still yet another embodiment at least about 300 degrees, in still yet another embodiment at least about 335 degrees, and/or in still yet another embodiment at least about 345 degrees. The first strap (5) may form a partial and/or substantially cylindrical shape having a space 20 for receiving a container (e.g., the container 30; FIGS. 7 and 8) within the strap (5) as shown in FIGS. 2, 3, 7, and 8. The strap (5) is adapted to partially encircle and/or grip a container disposed within the space 20. As such, the first strap (5) with its arc may have an inwardly biasing spring force due to its curvature and/or material properties to grip a container (e.g., the container 30; FIGS. 7 and 8) disposed within the space (20). The first strap (5) is beveled along a front, underside edge (12), which eases the insertion and removal of containers from the space 20 of the holder. Material used is resilient enough to return to original resting position.

The second strap (4) extends from the second attachment (6) (which extends from the base (8)). As such, the second strap (4) is spaced a distance X along the base (8) (i.e., along the longitudinal axis L-L′) from the first strap (5). The distance X may comprise from about 0 mm to about 150 mm, in another embodiment from about 15 mm to about 85 mm, in yet another embodiment from about 20 mm to about 70 mm, and in still yet another embodiment from about 30 mm to about 60 mm. In one embodiment the distance X is about 30 mm. The second strap (4) may comprise an arc having an angle of at least about 180 degrees, in another embodiment at least about 200 degrees, in another embodiment at least about 225 degrees, in yet another embodiment at least about 250 degrees, in still yet another embodiment at least about 300 degrees, in still yet another embodiment at least about 335 degrees, and/or in still yet another embodiment at least about 345 degrees. The second strap (4) may form a partial and/or substantially cylindrical shape forming the space 20 for receiving a container within the strap (4) as shown in FIGS. 2 and 3. The strap (4) is adapted to partially encircle and/or grip a container (e.g., the container 30; FIGS. 7 and 8) disposed within the space 20. As such, the second strap (4) with its arc may have an inwardly biasing spring force due to its curvature and/or material properties to grip a container disposed within the space (20). The second strap (4) may be beveled along a front, underside edge (13), which eases the insertion and removal of containers from the space 20 of the holder.

In one or more embodiments, the first and second straps (5) and (4) may be integral with the first and second attachments and/or the base (8) and/or be fabricated from the same material as the first and second attachments and/or the base. In the embodiment shown, the first and second straps (5) and (4) are curved such that each strap forms a substantially “U” shaped design (see, e.g., FIGS. 2 and 3). The first and second straps are disposed in an orientation that is perpendicular to the longitudinal axis L-L′. The first and second straps may have a radius of curvature such that each strap may at least partially encircle a container disposed within the space (20).

The material used to fabricate the first and second straps (5) and (4) may comprise a material that is resilient and/or has a memory sufficient to cause the first and second straps to return to their original shape and/or resting position after being bent, deformed, and/or manipulated such as during the installation and/or removal of a container from the holder 1 (i.e., from the space 20 within straps (5) and (4)). It is understood that in other embodiments, the first and second straps may not be integral with the first and second attachments and/or the base and/or may not be made of the same material as the first and second attachments and/or the base.

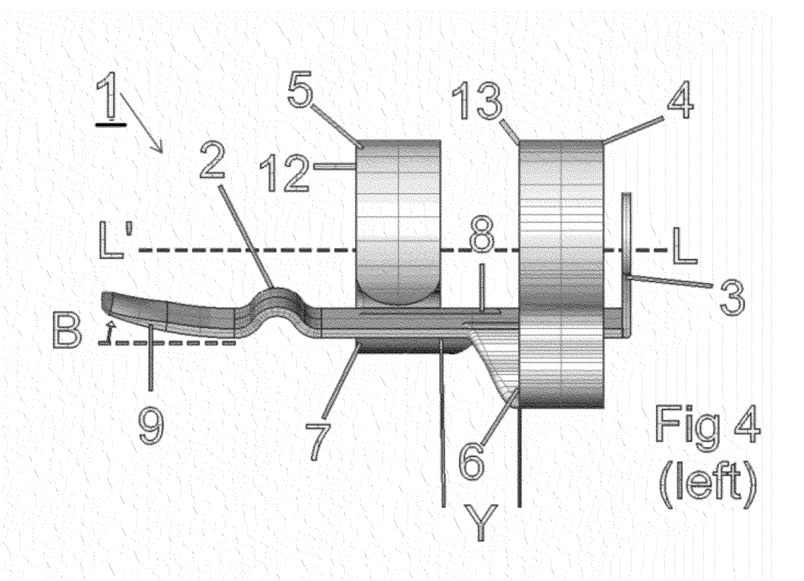

The container holder (1) may also comprise the front rest (9) as shown in the figures. The front rest (9) may serve as a guide for inserting a container within the holder. The front rest (9) may support and secures a container within the holder, particularly for containers greater than an 8 inches in overall length. In the embodiment shown, the front rest (9) is designed at an angle β of about 20 degrees in relation to longitudinal axis L-L′ (as shown in FIG. 4) to secure container by forcing container against the first strap (5). To ease entry of a container into the space 20, the front rest (9) is beveled along a front, top edge (14). Material used for the front rest (9) may comprise a material that is resilient and/or has a memory sufficient to cause the front rest to return to its original shape and/or resting position after being bent, deformed, and/or manipulated. Additionally, the front rest (9) may be fabricated as an integral component of and/or of the same material as the base (8).

Also, the container holder may comprise the articulating lip (2) as shown in the figures. The articulating lip (2) may comprise a convex curvature and be positioned between the base (8) and the front rest (9). The articulating lip (2) may comprise a material that is resilient and/or has a memory sufficient to cause the articulating lip to return to its original shape and/or resting position after being bent, deformed, and/or manipulated. In addition, the lip (2) may be fabricated as an integral component of and/or of the same material as the base (8) and/or the front rest (9). The lip (2) is adapted to align with and/or engage an indented ring (e.g., indented ring 32; FIGS. 7 and 8) along a neck of a water bottle (e.g., container 30), wherein the indented ring is common to most commercially available bottles.

The container holder in one or more embodiments may comprise an end stop (3). Similar to the other components of the container holder, the end stop (3) may be fabricated from the same material and be integral to the base (8). In the embodiment shown, the end stop (3) is perpendicular to longitudinal axis L-L′ (and the base (8)) and at an end of the base (8) opposite of the front rest (9) and articulating lip (2). The end stop assists in securing a container from movement along longitudinal axis L-L′ by engaging the bottom of a container and essentially pinning the bottom between the end stop and the articulating lip (2) and/or the front rest (9).

In operation, the container holder (1) is attached and/or connected to the first and second bars (11) and (10) of aerobar (50) by first extending the second strap (4) over the bar (10). The end stop (3) is maneuvered between the two bars (10) and (11). The next step is to extend the first strap (5) over the bar (11). To secure container holder onto the aerobar 50, the first attachment (7) is pushed with a minimal force against the bar (11) until the bar snaps into place within the first attachment space (22) and thus the first attachment (7) is snapped onto the bar (11). Then, the second attachment (6) is pushed with a minimal force against the bar (10) until the bar (10) snaps into place within the second attachment space (24) and thus the second attachment (6) is snapped onto the bar (10). It is understood that the order of the steps above may be altered in order to connect the holder 1 to the aerobar 50. In addition, one or more steps may be removed and/or added when the container holder as shown and described herein is connected to a bicycle frame, handle bars, and/or aerobars.

Once the container holder 1 is connected to the bicycle, a container (e.g., 30) is inserted into the space 20 of the holder (1) by introducing the container in a direction either substantially parallel to the base (8) (i.e., from the front) or more from the top of the holder such that the container's side and/or bottom force the first strap (5) and then the second strap (4) to expand, deform, and/or bend out of the way, permitting the container to be inserted therein. As the container is inserted into the holder (1) from either orientation or direction, the container may slide along the front rest (9) and/or the base (8) until it comes to rest within the space (20) against the front rest (9), articulating lip (2), base (8), and/or end stop (3) as shown in FIGS. 7 and 8. As set forth above, due to their resilient nature, the straps (4) and (5) will resume back to their original form and/or position to secure by the container within the holder (1). Additionally, the straps (4) and (5) may comprise an inwardly biasing spring force that further grips and secures the container within the holder (1).

Moreover, due to this design, the container may be easily and efficiently be removed and disengaged from the grip of the straps (4) and (5) by either pulling upwardly on the container, thus significantly moving, bending, and/or deforming the straps out of the way, or puling the container forward along a direction substantially parallel path to the base (8) (and/or longitudinal axis l-l′). In the latter method, the straps may or may not be moved, bent, and/or deformed to assist in permitting the container to be removed from within the holder. Again, due to the resilient nature of the straps, the straps will return to their original resting position and form. This movement of the container also forces the articulating lip (2) to release.

The beveling of the strap (4) and (5) enable easier insertion of the container from the front or top of the container as set forth above herein. Other embodiments may include adjustments to base (8) to accommodate wider or narrower spacing between the bars of an aerobar and/or handle bars. As shown and described herein, one of the benefits of one or more embodiments is that the first attachment (6) and second attachment (7) snap onto the aerobar to secure the container holder (1) without the need or use of mechanical fasteners such as, for example, clamps, screws, etc. In one embodiment, the container holder (1) is sized to fit bars with a diameter from about ⅞ inch to about 1 inch with a nominal center to center spread from about 1 inch to about 4 inch, in another embodiment with a nominal center to center spread from about 2 inches to about 3 inches, particularly of about 2½ inches (e.g., as shown in FIG. 3). Adjustments to base (8) and first strap (5) and second strap (4) allow for larger spreads between the bars of an aerobar.

The first strap (5) and second strap (4) comprise the same width to allow better security of container. However, it is understood that they may have the same, similar or completely different lengths and/or widths.

In one example, a container holder for mounting on a bicycle includes a base member, two flexible attachments integral to the base member adapted to connect to handle bars of a bicycle, two flexible, U-shaped straps integral to the base member and at least partially forming a cylindrical space for holding the container therein, and an end stop connected to the base member. The handle bars may comprise aerobars. The two flexible attachments comprise curved, inwardly biasing members that each partially encircle and grip a bar of the handle bars.

In another example, the container holder may be front or top loading. The container forces the first and second straps to open slightly. The front, underside of both straps may be beveled to ease security of the container. An articulating lip secures the container for the front to provide better securely over rough terrain. The straps are the same width to provide greater container security over rough terrain. In addition, an end stop is connected to the base to restrain moment. The container may be removed by pulling the container forward or pulling in an upward direction.

In certain examples, the container holder contains two inwardly biased, attachments that partially encircle and grip an aerobar so mechanical fasteners are not required. These inwardly biased, attachments may be adapted to included a inward spring force created by either the resiliency of the material or some other conventional means or method of creating a spring force.

In still certain other examples, a container holder for mounting on a bicycle includes a base member, two flexible attachments integral to the base member adapted to connect to handle bars of a bicycle, two flexible, U-shaped straps integral to the base member and at least partially forming a cylindrical space for holding the container therein, and an end stop connected to the base member. The handle bars may include aerobars. The two flexible attachments may include curved, inwardly biasing members that each partially encircle and grip a bar of the handle bars. The two flexible attachments do not comprise mechanical fasteners. The two flexible U-shaped straps may be adapted to receive containers having a variety of lengths and diameters. The container holder may also include an articulating lip connected to the base. The container holder may further comprise a front rest connected to the articulated lip. The articulating lip and front rest may be integral to the base. The two flexible, U-shaped straps may be connected and integral to the two flexible attachments.

Any and all documents cited in the Detailed Description are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this document shall govern.

While several devices and components thereof have been discussed in detail above, it should be understood that the components, features, configurations, and methods of using the devices discussed are not limited to the contexts provided above. In particular, components, features, configurations, and methods of use described in the context of one of the devices may be incorporated into any of the other devices. Furthermore, not limited to the further description provided below, additional and alternative suitable components, features, configurations, and methods of using the devices, as well as various ways in which the teachings herein may be combined and interchanged, will be apparent to those of ordinary skill in the art in view of the teachings herein.

What is claimed is:

1. A container holder for mounting on a bicycle comprising:
a base member;
two flexible attachments integral to the base member adapted to connect to handle bars of a bicycle;
two flexible, U-shaped straps integral to the base member and at least partially forming a cylindrical space for holding the container therein; and
an end stop connected to the base member.

2. The container holder of claim 1, wherein the handle bars comprise aerobars.

3. The container holder of claim 1, wherein the two flexible attachments comprise curved, inwardly biasing members that each partially encircle and grip a bar of the handle bars.

4. The container holder of claim 1, wherein the two flexible attachments do not comprise mechanical fasteners.

5. The container holder of claim 1, wherein the two flexible U-shaped straps are adapted to receive containers having a variety of lengths and diameters.

6. The container holder of claim 1, further comprising an articulating lip connected to the base.

7. The container holder of claim 6, further comprising a front rest connected to the articulated lip.

8. The container holder of claim 7, wherein the articulating lip and front rest are integral to the base.

9. The container holder of claim 1, wherein the two flexible, U-shaped straps are connected and integral to the two flexible attachments.
